(19) United States
(12) Patent Application Publication
(10) Pub. No.: US 2005/0223039 A1
(43) Pub. Date: Oct. 6, 2005

(54) Method and apparatus for playing multimedia play list and storage medium therefor

(75) Inventors: Du-il Kim, Suwon-si (KR); Seong-kook Shin, Seoul (KR); Hee-yeon Kim, Suwon-si (KR); Young-yoon Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/098,566

(22) Filed: Apr. 5, 2005

Related U.S. Application Data
(60) Provisional application No. 60/559,031, filed on Apr. 5, 2004.

(30) Foreign Application Priority Data
May 11, 2004 (KR) 10-2004-0033116

(51) Int. Cl. G06F 17/00

(52) U.S. Cl. 707/104.1

(57) ABSTRACT

A method and apparatus are provided for playing a multimedia play list combined with audio representing content of an album in a multimedia application, and a storage medium storing a program for executing the method and a MultiPhotoVideo or MusicPhotoVideo (MPV) file. The method includes detecting information regarding an asset combined with audio representing content of the asset, and playing the audio and index information of the album based on the information regarding the asset when the multimedia play list is played. Accordingly, a user can recognize content of an album due to the audio without seeing the content of the album.

### BACKGROUND OF THE INVENTION

This application claims priority from U.S. Patent Provisional Application No. 60/559,031, filed on Apr. 5, 2004 in the United States Patent and Trademark Office, and Korean Patent Application No. 10-2004-0033116, filed on May 11, 2004 in the Korean Intellectual Property Office, the disclosures of which are incorporated herein by reference.

1. Field of the Invention

Apparatuses and methods consistent with the present invention relate to a multimedia play list in multimedia application, and more particularly, to playing a multimedia play list combined with audio representing content of an album defined in terms of meaning, and a storage medium storing a program for executing the method or a file.

2. Description of the Related Art

Recently, it has been universalized to produce content including various media such as digital pictures, i.e., still images, video, digital audio, and text using a digital camera, a digital camcorder, and a digital audio player supporting a Motion Picture Experts Group (MPEG) audio file, i.e., an MP3 file, or a Microsoft Window Media Audio (WMA) file. When a content producing device produces such content, it can generated attributed data, i.e., metadata, including content playback order or a content reproducing method. For example, when producing content by dividing photos captured by a digital camera in terms of meaning using a slideshow or panorama function, attribute data of the content can be determined. When the slideshow function is used, the attribute data may include an order in which the photos are displayed in a slideshow and a time interval between the photos. When the panorama function is used, the attribute data may include a relation between the photos. Such attribute data is stored in the digital camera together with the content.

The content produced using the content producing device may be played in a personal computer (PC), a media server, or a multimedia player. In addition, the content may be edited in the PC or the media server. Accordingly, a user can enjoy the original content produced in the content producing device or the edited content using a PC or various types of multimedia players. The content may be provided to the user through online service.

However, since inter-operability between a multimedia player including a PC and a content producing device is very weak, attribute data generated in the content producing device is lost without being transmitted to the multimedia player. For example, when content produced using the slideshow function is transmitted from a digital camera to a PC connected to the digital camera through a universal serial bus (USB) cable, photo data is transmitted to the PC, but attribute data corresponding to the photo data is lost. This is because the digital camera and the PC have different information structures and data processing methods. Accordingly, the multimedia player cannot provide the content in accordance with the attribute data to users.

To overcome the weak inter-operability between a multimedia player such as a PC and a content producing device, the Optical Storage Technology Association (OSTA) and the International Imaging Industry Association (I3A) are working on standardization of a MultiPhotoVideo or MusicPhotoVideo (MPV).

An MPV specification is provided mainly to facilitate processing, exchanging, and playback of a multimedia data set including digital photos, video, and digital audio, which are stored in a storage medium such as an optical disk, a memory card, or a computer hard disk or exchanged according to an Internet protocol.

The MPV specification published on an OSTA homepage (www.osta.org) includes schema defining a structure of MPV content, practices establishing expectations and processes for how MPV content is handled, profiles that are a set of schema, practices and additional content, and referenced specifications that are other specifications used by the MPV specification.

In addition, the MPV specification includes an MPV core and a profile using the MPV core. The MPV core fundamentally includes a collection, metadata, and an identifier. The collection includes a manifest, an asset list, and marked assets.

The manifest groups all MPV elements into a single extensible markup language (XML) document. The manifest contains at least one asset list or manifest links. The manifest contains different MPV elements according to whether metadata is an element describing a basic profile or an element a presentation profile.

FIG. 1 illustrates an MPV file structure 100 of a manifest 110 when metadata is a basic profile. The manifest 110 includes Metadata 120 describing a basic profile, AssetList 130, and MarkedAssets 140.

The AssetList 130 is a set of assets that each has a unique local identifier in an MPV collection and contains album position (or route) information. Assets contained in the AssetList 130 are divided into simple media assets 131 and composite media assets 132. The simple media assets 131 include entities: Still (i.e., a digital picture), Video, Audio, Text, Print, Document, and ManifestLink. The composite media assets 132 include entities: StillWithAudio, AudioWithStills, StillMultishotSequence, and StillPanoramaSequence.

FIG. 2 illustrates an MPV file structure 200 of a manifest 210 when metadata is a presentation profile. The manifest 210 includes Metadata 220 describing a presentation profile, an Album 230, and an AssetList 240.

The Album 230 includes metadata 231, a foreground 232 representing media assets displayed on a foreground when content corresponding to an album is played, and a background 233 representing media assets used as a background when the content corresponding to the album is played. The AssetList 240 includes simple media assets 241 and composite media assets 242 like the AssetList 130 shown in FIG. 1.

All of the assets included in the AssetList 130 shown in FIG. 1 and the AssetList 240 shown in FIG. 2 are identified using five kinds of identifiers: an instanceID that is a unique identifier for each asset, a contentID generated whenever an asset is used for a predetermined purpose, a lastURL indicating a name of a path to an asset and the asset's file name, an id indicating a local variable in the metadata, and a documentID same for both of original data and changed data.

However, a ManifestLink is an asset indicating another MPV file. Accordingly, when a multimedia player parses an MPV file recorded in a storage medium and plays a multimedia play list (or an asset list), since assets such as a digital picture, video, audio, text, and a document are provided by corresponding media, a user can recognize content of an album based on the play list. However, since a play list provided based on the ManifestLink asset is an index of the album, the user cannot recognize the content of the album. As a result, as ManifestLink assets increase in the asset list, it becomes more difficult for the user to find a desired album in the play list.

### SUMMARY OF THE INVENTION

The present invention provides a method and apparatus for playing a play list combined with audio representing content of an album in a multimedia application, and a storage medium storing a program for executing the method and an MPV file.

The present invention also provides a method and apparatus for playing a multimedia play list combined with audio allowing a user to infer content of an album without viewing the content in a multimedia application, and a storage medium storing a program for executing the method and an MPV file.

According to an aspect of the present invention, there is provided a method of playing a play list for at least one album, including detecting an asset combined with audio representing content of the album, and playing the audio based on information of the asset.

According to another aspect of the present invention, there is provided a method of playing a multimedia play list for at least one album using an MPV file, including detecting a first asset combined with audio representing content of the album in the MPV file, detecting at least one element at a lower level below the first asset in the MPV file, and playing index information of the album and the audio based on information of the element.

According to still another aspect of the present invention, there is provided a method of playing a multimedia play list for at least one album using an MPV file, including detecting one among a first asset combined with audio representing content of the album and a second asset designating the first asset in the MPV file; when the second asset is detected, detecting the first asset in the MPV file using information of the second asset; and when the first asset is detected, playing the audio using information of the first asset.

According to yet another aspect of the present invention, there is provided an apparatus for playing a play list for at least one album, including a storage medium storing media presenting content of the album and a file for playing the play list for the album, a file software unit parsing information of the file and detecting an asset combined with an audio representing the content of the album and information of the asset, a play controller playing a file of the audio among the media stored in the storage medium-based on the information of the asset detected by the file software unit, and an output unit outputting the audio according to control by the play controller.

According to a further aspect of the present invention, there is provided a storage medium storing a program for executing a method of playing a play list for at least one album, wherein the method includes detecting an asset combined with audio representing content of the album, and playing the audio based on information of the asset.

According to another aspect of the present invention, there is provided a storage medium storing a program for executing a method of playing a multimedia play list for at least one album using an MPV file, wherein the method includes detecting a first asset combined with audio representing content of the album in the MPV file, detecting at least one element at a lower level below the first asset in the MPV file, and playing index information of the album and the audio based on information of the element.

According to still another aspect of the present invention, there is provided a storage medium storing a program for executing a method of playing a multimedia play list for at least one album using an MPV file, wherein the method includes detecting one among a first asset combined with audio representing content of the album and a second asset designating the first asset in the MPV file; when the second asset is detected, detecting the first asset in the MPV file using information of the second asset; and when the first asset is detected, playing the audio using information of the first asset.

According to yet another aspect of the present invention, there is provided a storage medium storing an MTV file for playing a multimedia play list for at least one album, wherein the MPV file includes an asset combined with audio representing content of the album, at least one element defined at a lower level below the asset, an asset providing index information of the album detected based on information of the element, and an asset providing index information of the audio detected based on the information of the element.

According to a further aspect of the present invention, there is provided a storage medium storing an MPV file for playing a multimedia play list for at least one album, wherein the MPV file includes an asset combined with audio representing content of the album, at least one element defined at a lower level below the asset, an asset providing index information of the album detected based on information of the element, an asset providing index information of the audio detected based on the information of the element, and an asset designating the asset combined with the audio.

### BRIEF DESCRIPTION OF THE DRAWINGS

The above and other aspects of the present invention will become more apparent by describing in detail exemplary embodiments thereof with reference to the attached drawings in which:

FIG. 1 is illustrates an MPV file structure of a manifest when metadata is a basic profile;

FIG. 2 illustrates an MPV file structure of a manifest when metadata is a presentation profile;

FIG. 3 is a functional block diagram of an Information Technology (IT) or Consumer Electronics (CE) device capable of generating an MPV file according to an exemplary embodiment of the present invention;

FIG. 4 illustrates an example of an MPV file including a ManifestLinkWithAudio asset;

FIG. 5 is a diagram describing a position of schema information with respect to the ManifestLinkWithAudio asset;

FIG. 6 is a full description of the ManifestLinkWithAudio asset shown in FIG. 4;

FIG. 7 is a type summary diagram of the ManifestLinkWithAudio asset shown in FIG. 4;

FIG. 8 is a diagram describing an AudioVolume shown in FIG. 4;

FIG. 9 is a diagram describing an AudioPlayingTime shown in FIG. 4;

FIG. 10 is a diagram describing an AudioFileSize shown in FIG. 4;

FIG. 11 illustrates an example of a source code of an MPV file including the ManifestLinkWithAudio asset in an exemplary embodiment of the present invention;

FIG. 12 illustrates an example of an MPV file including the ManifestLinkWithAudio asset and a ManifestLinkWithAudioRef asset;

FIG. 13 is a diagram describing the ManifestLinkWithAudioRef shown in FIG. 12;

FIG. 14 illustrates an example of a source code of an MPV file including the ManifestLinkWithAudioRef asset and the ManifestLinkWithAudio asset in an exemplary embodiment of the present invention;

FIG. 15 is a functional block diagram of an IT or CE device capable of playing a multimedia play list combined with audio according to an exemplary embodiment of the present invention; and

FIG. 16 is a flowchart of a method of playing the multimedia play list according to an exemplary embodiment of the present invention.

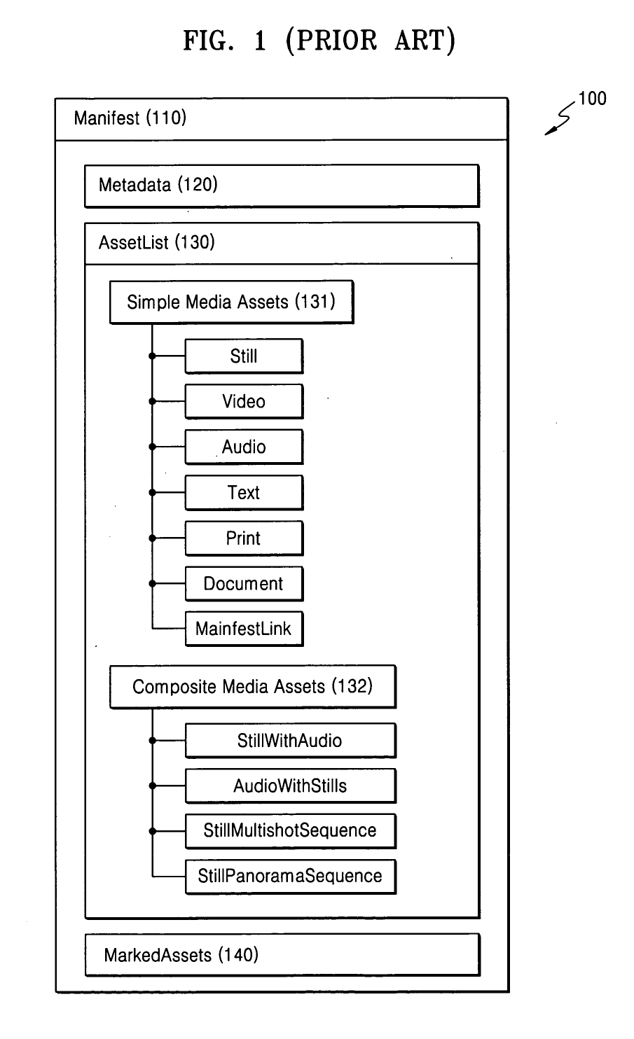

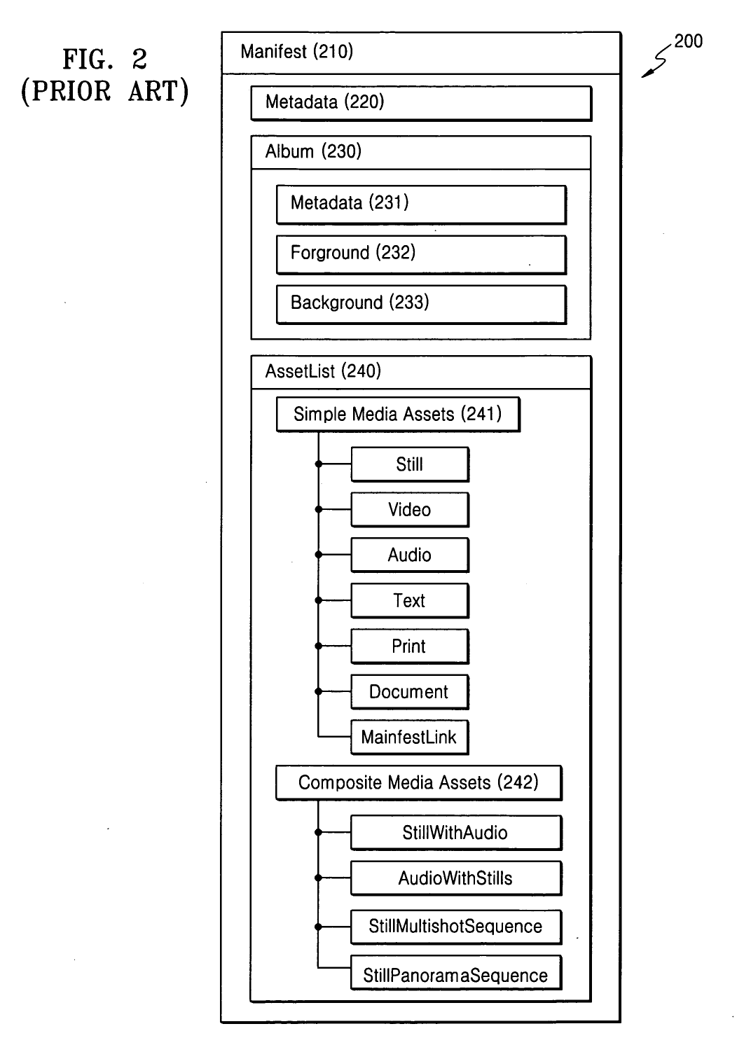

### DETAILED DESCRIPTION OF EXEMPLARY EMBODIMENTS OF THE INVENTION

Hereinafter, exemplary embodiments of the present invention will be described in detail with reference to the attached drawings.

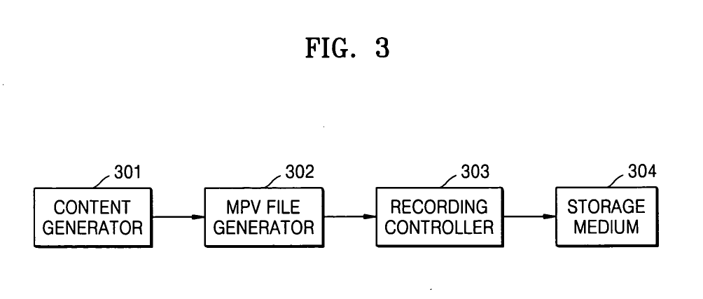

FIG. 3 is a functional block diagram of an Information Technology (IT) or Consumer Electronics (CE) device capable of generating an MPV file according to an exemplary embodiment of the present invention. The CE device may be a digital versatile disk (DVD) recorder, a digital camera, a digital camcorder, an MP3 player, or the like. The IT device may be a personal computer (PC). Referring to FIG. 3, the CE or IT device includes a content generator 301, an MPV file generator 302, a recording controller 303, and a storage medium 304.

The content generator 301 generates content containing media corresponding to simple media assets or composite media assets, which are defined in an MPV standard. The media corresponding to the simple media assets may be JPG files of captured digital photos when the device is a digital camera, may be video clip files when the device is a camcorder, may be MP3 files of digital audio when the device is an MP3 player, and may be text files when the device is a PC. The media corresponding to the composite media assets may be a combination of a digital photo and digital audio, a multishot sequence of digital photos, a panorama sequence of digital photos, or multimedia combined with text data.

The MPV file generator 302 receives the content generated by the content generator 301 and generates an MPV file according to an MPV specification. When the MPV file is generated, a ManifestLinkWithAudio asset and ManifestLinkWithAudioRef asset may be included in the MPV file to combine audio representing the content of an album with a multimedia play list (or a play list). The ManifestLinkWithAudio asset is a combination of a single audio asset and a ManifestLink asset. Accordingly, identification information of the audio asset providing index information of the audio corresponding to the album and identification information of the Manifestlink asset providing index information can be defined at a lower level below the ManifestLinkWithAudio asset. The ManifestLinkWithAudioRef asset is an element designating a location of the ManifestLinkWithAudio asset.

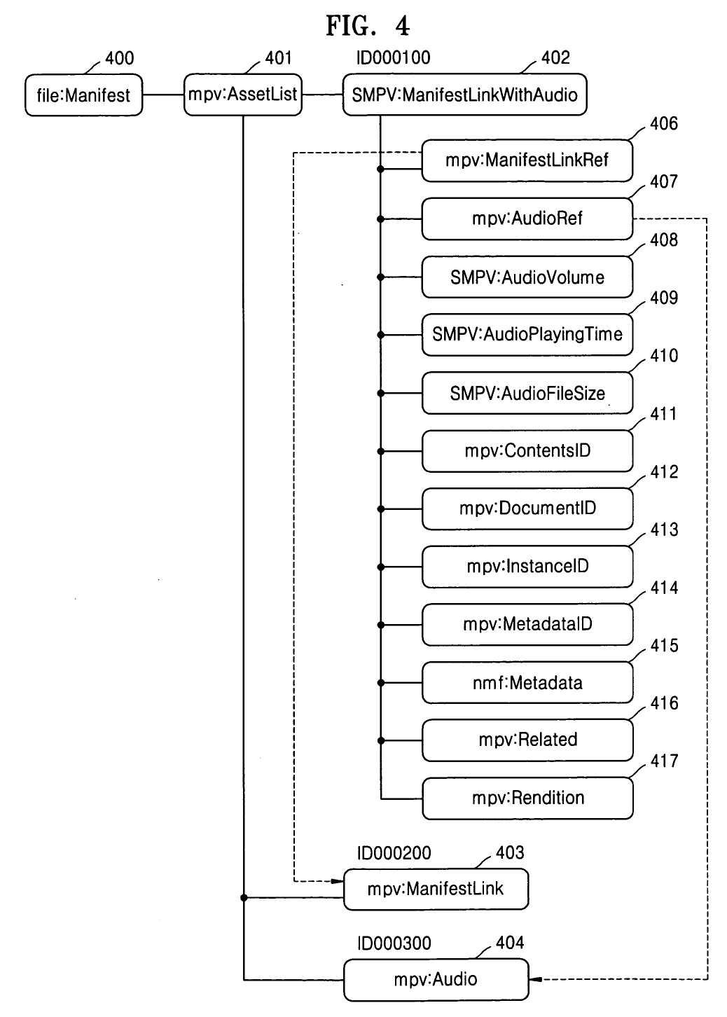

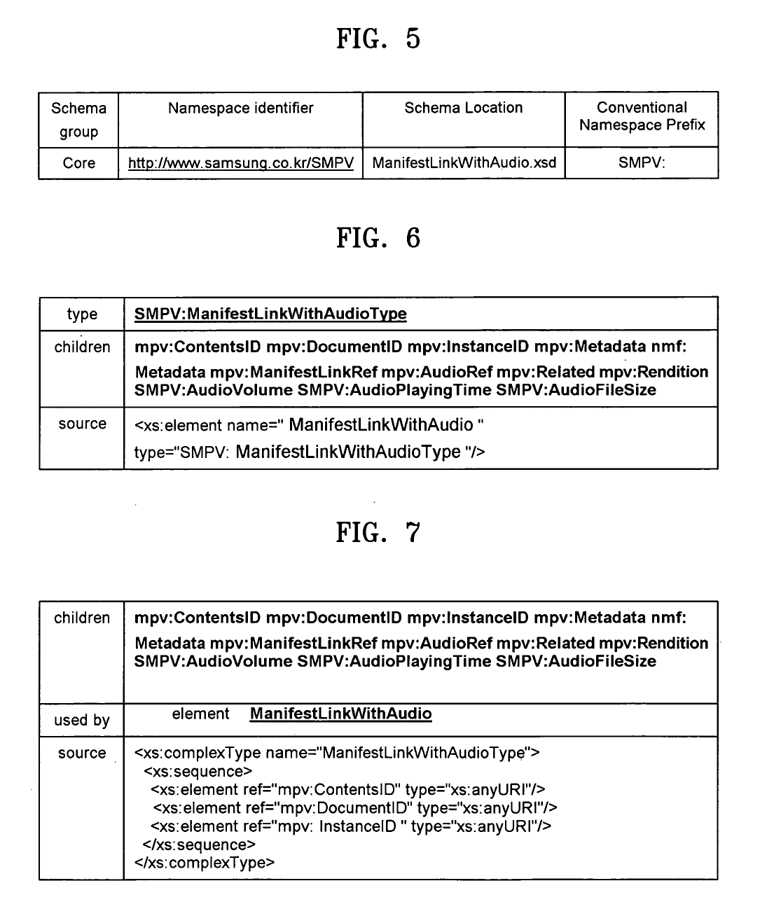

FIG. 4 illustrates an example of an MPV file including a ManifestLinkWithAudio asset when metadata of a Manifest 400 is an element describing a basic profile. In FIG. 4, a ManifestLinkWithAudioRef asset is not considered. As show in FIG. 4, a ManifestLinkWithAudio asset 402 is at a lower level (or a children level) below an AssetList 401. As shown in FIG. 5, schema information of the ManifestLinkWithAudio asset 402 has a namespace prefix, Samsung MPV (SMPV); and a namespace identifier, http://www.samsung.co.kr/SMPV, and is defined at a schema location, ManifestLinkWithAudio.xsd.

As shown in FIG. 4, elements, a ManifestLinkRef 406, an AudioRef 407, an AudioVolume 408, an AudioPlayingTime 409, an AudioFileSize 410, a ContentID 411, a DocumentID 412, an InstanceID 413, a Metadata ID 414, a Metadata 415, a Related 416, and a Rendition 417, are included in a lower level below the ManifestLinkWithAudio asset 402. In FIG. 4, “mpv”, “SMPV”, and “nmf” attached to the elements are namespaces in extensible markup language (XML). The elements having the “SMPV” as the namespace are new ones presented in the present invention. The elements having the “mpv” or the “nmf” have been presented by OSTA and are described in “MPV-Core Specification” disclosed on the OSTA homepage, and thus a detailed description thereof will be omitted.

FIG. 6 is a full description of the ManifestLinkWithAudio asset 402 shown in FIG. 4. FIG. 7 is a type summary diagram of the ManifestLinkWithAudio asset shown in FIG. 4.

In FIG. 4, the ManifestLinkRef 406 is an asset having a reference identifier (called idRef) corresponding to an identifier (ID) of a ManifestLink 403. The AudioRef 407 is an asset having an ID of an audio asset 404 combined with the ManifestLink 403.

Referring to FIG. 4, the ManifestLink 403 and the audio asset 404 are at a lower level below the AssetList 401. When an MPV file is parsed to play a multimedia play list, the ManifestLink 403 is searched for using information of the ManifestLinkRef 406 and the Audio 404 is searched for using information of the AudioRef 407.

The ManifestLink 403 is an element or an asset designating an album or an MPV file. The Audio 404 is an element or an asset designating a location where a playable audio file such as an MP3 file or a WMA file is stored.

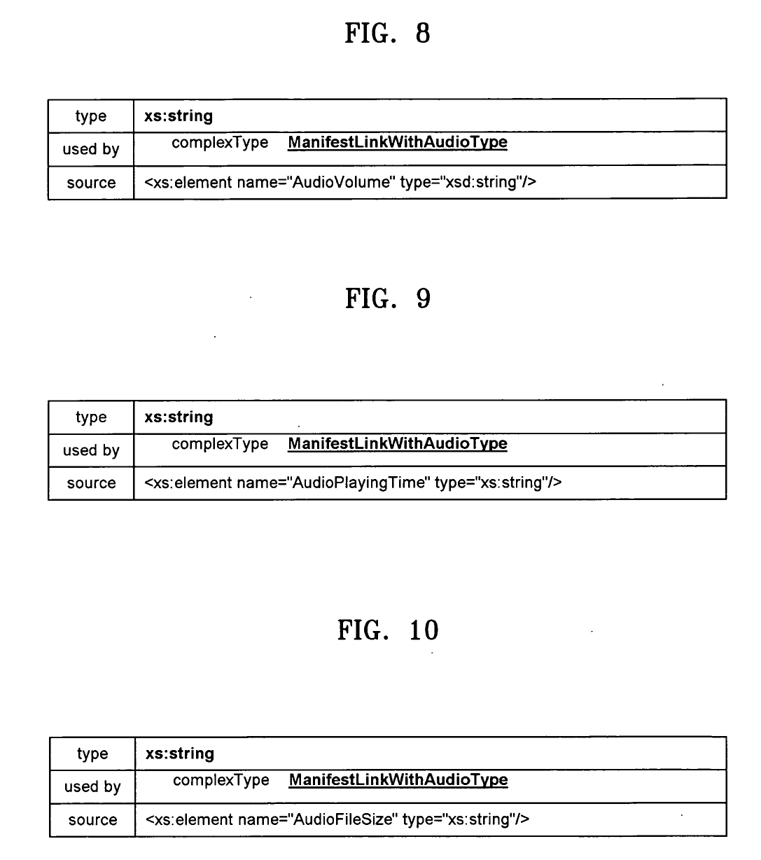

FIG. 8 is a diagram describing the AudioVolume 408 shown in FIG. 4. The AudioVolume 408 can be defined by a percentage using an integer number from 0 to 100 with respect to original sound volume. Accordingly, when the AudioVolume 408 has a value of 0, an audio volume level is 0. If the AudioVolume 408 is not set, the AudioVolume 408 is assumed to have a value of 100 to protect original audio.

FIG. 9 is a diagram describing the AudioPlayingTime 409 shown in FIG. 4. A value of the AudioPlayingTime 409 may define a playing time of audio in seconds. The audio playing time may be expressed in a decimal number. For example, when the value of the AudioPlayingTime 409 is 7.2, the audio playing time is 7.2 seconds. If the AudioPlayingTime 409 is not defined, an audio playing time is unknown.

FIG. 10 is a diagram describing the AudioFileSize 410 shown in FIG. 4. The AudioFileSize 410 defines an audio file size in bytes. For example, when a value of the AudioFileSize 410 is set to 2433, an audio file has a size of 2433 bytes. However, when the value of the AudioFileSize 410 is not set, an audio file size is unknown.

The AudioVolume 408 and the AudioPlayingTime 409 are information on the playback characteristics of the audio representing content of the album.

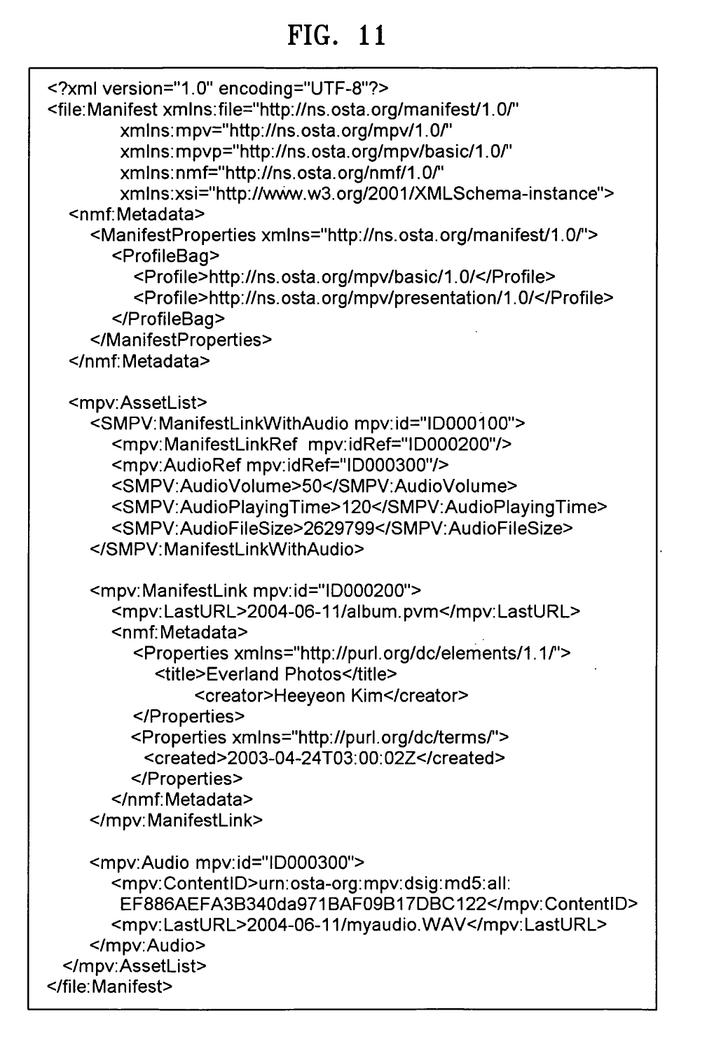

FIG. 11 illustrates an example of a source code of an MPV file when a ManifestLinkWithAudio asset is present at a lower level below an AssetList in an exemplary embodiment of the present invention. Referring to FIG. 11, the AssetList includes a ManifestLinkWithAudio asset, a ManifestLink asset, and an Audio asset as lower level assets (or children elements).

The ManifestLinkWithAudio asset includes a ManifestLinkRef asset having mpv:idRef=“ID000200”, an AudioRef asset having mpv:idRef=“ID000300”, AudioVolume attribute data having an audio volume of 50, AudioPlayingTime attribute data having an audio playing time of 120, and AudioFileSize attribute data having an audio file size of 2629799 as lower level assets or attribute data (or children elements).

Referring to FIG. 11, both of the idRef of the ManifestLinkRef asset and an id of the ManifestLink that is a lower level asset of the AssetList are “ID000200”, which means that the ManifestLinkRef asset is linked to the ManifestLink asset. In addition, both of the idRef of the AudioRef asset and an id of the Audio asset that is a lower level asset of the AssetList are “ID000300”, which means that the AudioRef asset is linked to the Audio asset. A LastURL of the ManifestLink asset is set to “2004-06-11/album.pvm”, which means that the ManifestLink asset is linked to 2004-06-11/album.pvm. A LastURL of the Audio asset refers to a “2004-06-11/myaudio.WVA” file, which means that referenced audio is a WAV file.

Thus, when the ManifestLink asset is searched for using idRef of the ManifestLink asset, the “2004-06-11/album.pvm” file is searched for in a storage medium (not shown) using the LastURL of the ManifestLink asset, and then the content of the “2004-06-11/album.pvm” file is played. In addition, when the Audio asset is searched for using the id of the Audio asset, the “2004-06-11/myaudio.WVA” file is searched for in the storage medium using the LastURL of the Audio asset, and then the content of the “2004-06-11/myaudio.WVA” file is played.

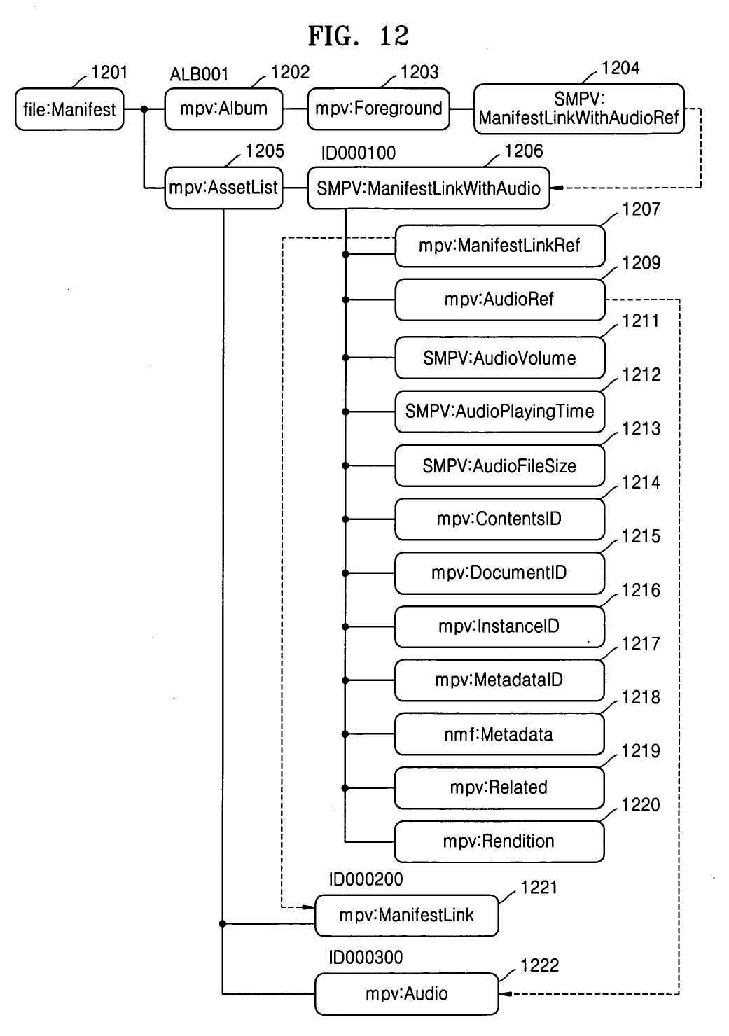

FIG. 12 illustrates an example of an MPV file generated by the MPV file generator 302 to include the ManifestLinkWithAudio asset and a ManifestLinkWithAudioRef asset. Here, metadata of a Manifest 1201 is an element describing a presentation profile. The example shown in FIG. 12 is different from that shown in FIG. 4 in that a Foreground asset 1203 included in an Album asset 1202 includes as a lower level asset a ManifestLinkWithAudioRef 1204 asset having an idRef having the same value as an id of a ManifestLinkWithAudio asset 1206 at a lower level below an AssetList 1205. Accordingly, the ManifestLinkWithAudio asset 1206 is searched for using the idRef of the ManifestLinkWithAudioRef 1204.

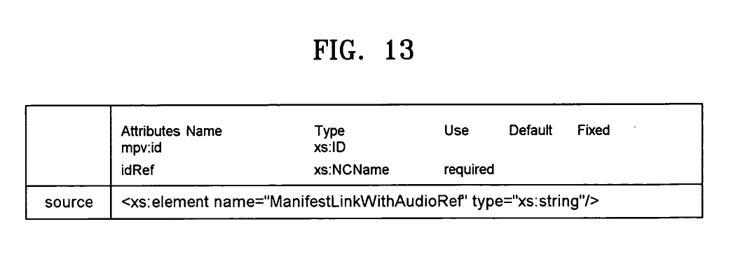

FIG. 13 is a diagram describing the ManifestLinkWithAudioRef 1204 shown in FIG. 12. Other assets 1209 through 1222 are the same as corresponding assets 403, 404, and 406 through 417 shown in FIG. 4, and thus a description thereof will be omitted.

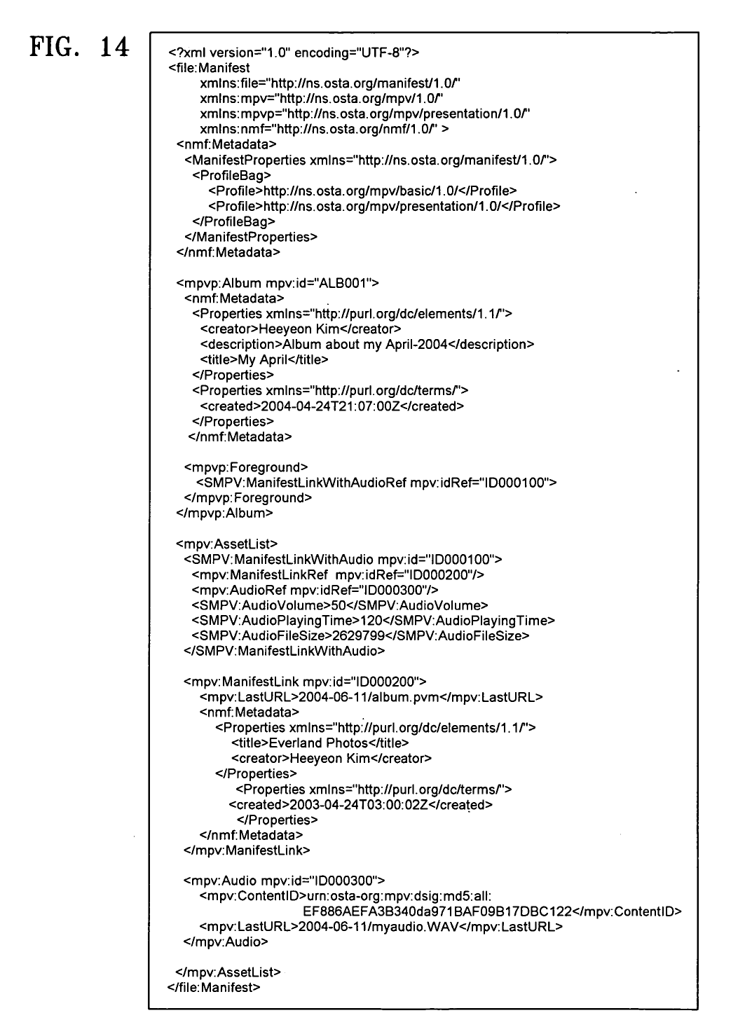

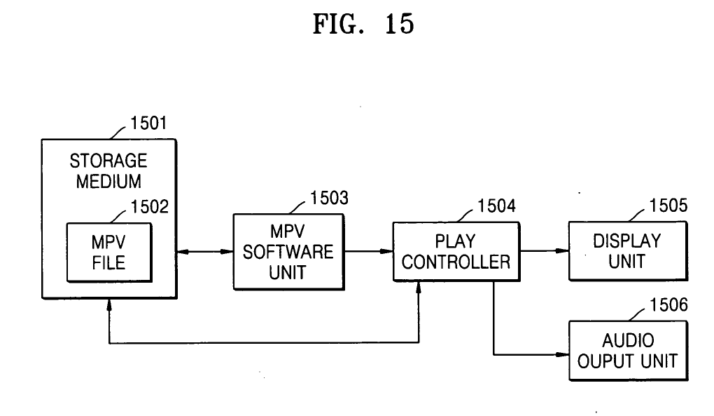

FIG. 14 illustrates an example of a source code of an MPV file including a ManifestLinkWithAudioRef asset and a ManifestLinkWithAudio asset in an exemplary embodiment of the present invention. The source code shown in FIG. 14 is different from that shown in FIG. 11 in that the ManifestLinkWithAudioRef asset is included as a lower level asset of a Foreground asset included in an Album asset and has an idRef having the same value as an id of the ManifestLinkWithAudio asset at a lower level below an AssetList. Referring to FIG. 14, both of the id of the ManifestLinkWithAudio asset and the idRef of the ManifestLnkWithAudioRef are “ID000100”.

If an MPV file having a structure in which the ManifestLinkWithAudio asset is at a lower level below the AssetList or an MPV file having a structure in which the ManifestLinkWithAudioRef asset is at a lower level below the Foreground asset of an album and the ManifestLinkWithAudio asset is at a lower level below the AssetList is generated, the recording controller 303 shown in FIG. 3 records the MPV file in the storage medium 304. The recording controller 303 may record the MPV file in a predetermined area of the storage medium 304. For example, the predetermined area may be a file system area defined in the storage medium 304. The storage medium 304 may be a memory, a memory stick, an optical disk, or a hard disk. At least one album file and the audio file representing content of the album file may be stored in the storage medium 304.

FIG. 15 is a functional block diagram of an IT or CE device capable of playing a multimedia play list combined with audio according to an exemplary embodiment of the present invention. The device includes a storage medium 1501, an MPV software unit 1503, a play controller 1504, a display unit 1505, and an audio output unit 1506.

The storage medium 1501 may be a memory, a memory stick, an optical disk, or a hard disk. An MPV file 1502 having a structure according to an exemplary embodiment of the present invention is recorded in the storage medium 1501. As shown in FIGS. 4 through 14, the MPV file 1502 may have a structure in which a ManifestLinkWithAudio asset is at a lower level below an AssetList or a structure in which a ManifestLinkWithAudioRef asset is at a lower level below a Foreground asset of an album and the ManifestLinkWithAudio asset is at a lower level below the AssetList. In addition, at least one album file and the audio file representing content of the album file may be stored in the storage medium 1501.

The MPV software unit 1503 parses various assets and various types of attribute data which are recorded in the MPV file 1502 and provides information necessary to play media recorded in a user area of the storage medium 1501 to the play controller 1504. In particular, to play a multimedia play list according to an exemplary embodiment of the present invention, the MPV software unit 1503 parses the MPV file 1502, searches for an asset corresponding to a reference ID according to which of the ManifestLinkWithAudio asset and the ManifestLinkWithAudioRef asset is detected, and detects information on the searched asset. Here, an Audio asset corresponding to a ManifestLink asset is also detected. Thus, when index information of an album based on the ManifestLink asset is provided in the form of a multimedia play list, information of an audio file is provided together so that audio representing content of the album can be played. The information of an audio file may be the LastURL of the audio file.

In addition, when audio attribute data included at a lower level below the ManifestLinkWithAudio asset shown in FIG. 4 or 12 is detected, the MPV software unit 1503 parses the detected audio attribute data and outputs a parsing result.

Upon receiving the parsing result from the MPV software unit 1503, the play controller 1504 controls media recorded in the user area of the storage medium 1501 to be played based on the parsing result. Here, the ManifestLink asset provides an index of an album, and the play controller 1504 controls the index of the album to be played on the multimedia play list. The play controller 1504 reads from the storage medium 1501 the audio file corresponding to the ManifestLink asset using the information of the audio file from the MPV software unit 1503 and can control the read audio file to be played together with the index of the album. Accordingly, the media recorded in a user area on the storage medium 1501 may include the audio file.

The display unit 1505 displays media corresponding to video such as digital photos provided from the play controller 1504. The audio output unit 1506 outputs an audio signal received from the play controller 1504. In particular, the audio output unit 1506 outputs audio corresponding to the multimedia play list played in the form of information such as the index of the album so that a user can recognize the content of the album. The display unit 1505 and the audio output unit 1506 may be defined as output units outputting video and audio, respectively.

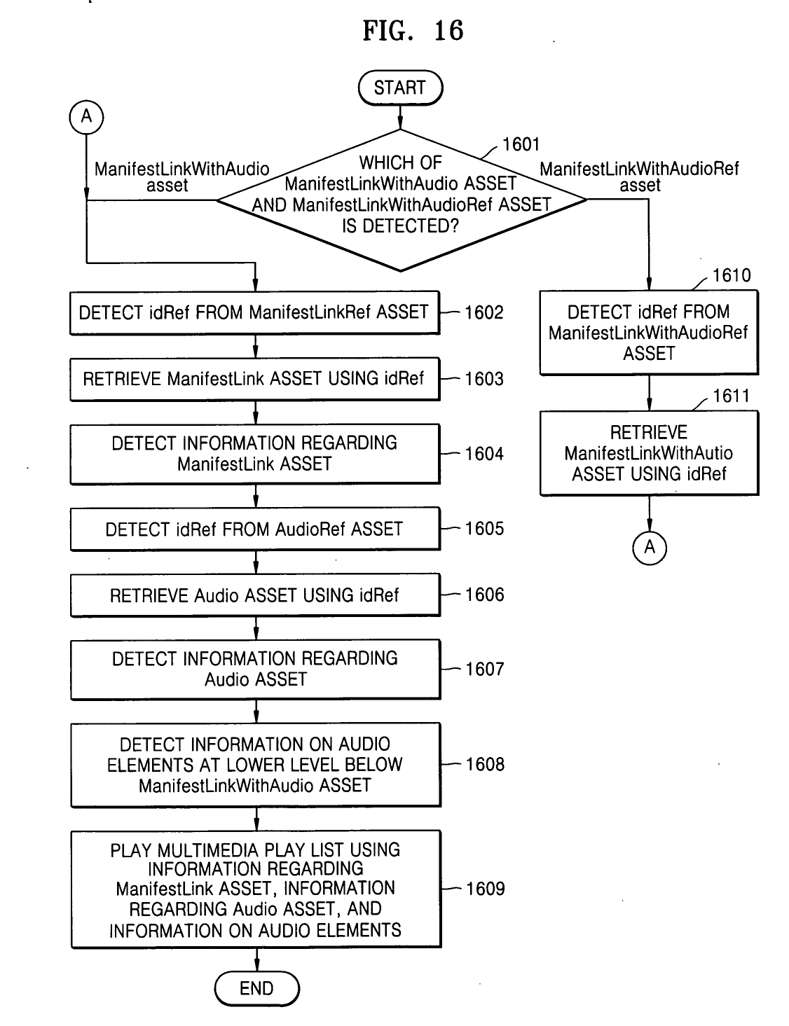

FIG. 16 is a flowchart of a method of playing a multimedia play list according to an exemplary embodiment of the present invention. While an MPV file is parsed using MPV software, it is determined which of a ManifestLinkWithAudio asset and a ManifestLinkWithAudioRef asset is detected in operation 1601. When it is determined that the ManifestLinkWithAudio asset is detected, a reference ID “mpv:idRef” is detected from a ManifestLinkRef asset at a lower level below the ManifestLinkWithAudio asset in operation 1602.

A ManifestLink asset is retrieved using the idRef in operation 1603. In other words, the ManifestLink asset having an ID identical with the idRef is retrieved. If the MPV file has the structure shown in FIG. 4, the ManifestLink asset having the ID identical with the idRef is retrieved from the same level as the ManifestLinkWithAudio asset.

Information of the retrieved ManifestLink asset is detected in operation 1604. In other words, metadata such as a LastURL or a title of an album is detected. Since the LastURL is an element referring to an index of an album based on the ManifestLink asset, it is obtained in a form like “2004-06-11/album.pvm” as shown in FIG. 11. The title of an album is obtained in a form like “Everland Photos” as shown in FIG. 11.

A reference ID “mpv:idRef”is detected from an AudioRef asset at a lower level below the ManifestLinkWithAudio asset in operation 1605. An Audio asset is retrieved using the detected idRef in operation 1606. In other words, the Audio asset having an ID identical with the idRef is retrieved. When the MPV file has the structure shown in FIG. 4, the Audio asset is retrieved from the same level as the ManifestLinkWithAudio asset.

Information of the Audio asset is detected in operation 1607. In other words, information such as a contentID or a lastURL of the Audio asset is detected. When the MPV file is configured as shown in FIG. 11, the contentID is “EF886AEFA3B340da971BAF09B17DBC122” and the lastURL is “2004-06-11/myaudio.WAV”.

Information on audio elements at a lower level below the ManifestLinkWithAudio asset is detected in operation 1608. When the MPV file has the structure shown in FIG. 4, the audio elements are AudioVolume, AudioPlayingTime, and AudioFileSize. Referring to FIG. 11, the detected information on the audio elements is as follows: a value of the AudioVolume is 50; a value of the AudioPlayingTime is 120; and a value of the AudioFileSize is 2629799. Since the audio elements are optional, no audio elements or one or more audio elements may be present at the lower level below the ManifestLinkWithAudio asset.

In operation 1609, a multimedia play list is played using the information of the ManifestLink asset detected in operation 1604, the information of the Audio asset detected in operation 1607, and the information on the audio elements detected in operation 1608. Here, data of an audio file combined with the ManifestLink asset is read from a storage medium based on the information of the Audio asset and is provided as information representing content of an album corresponding to the ManifestLink asset. The audio file data may include a description on the content of the album or a particular phrase or word making a user recognize the content.

When it is determined that the ManifestLinkWithAudioRef asset is detected in operation 1601, the MPV file has the structure shown in FIG. 12. A reference ID “mpv:idRef” is detected from the ManifestlinkWithAudioRef asset in operation 1610. A ManifestLinkWithAudio asset having an ID identical with the detected idRef is retrieved in operation 1611. After the ManifestLnkWithAudio asset is retrieved, the method goes to operation 1602. Here, information of the ManifestLinkWithAudio asset having the ID identical with the detected idRef, information of an Audio asset having an ID identical with an idRef detected from an AudioRef asset, and information on audio elements may be different from the information detected through the above-described operations 1602 through 1608.

A program for executing a method of playing a multimedia play list and an MPV file structure allowing the multimedia play list to be played, according to exemplary embodiments of the preset invention, can also be embodied as computer readable codes on a computer readable storage medium. The computer readable storage medium is any data storage device that can store data which can be thereafter read by a computer-system. Examples of the computer readable storage medium include read-only memory (ROM), random-access memory (RAM), CD-ROMs, magnetic tapes, floppy disks, optical data storage devices, and carrier waves (such as data transmission through the Internet). The computer readable storage medium can also be distributed over network coupled computer systems so that the computer readable code is stored and executed in a distributed fashion. Also, functional programs, codes, and code segments for accomplishing the method of playing a multimedia play list can be easily construed by programmers skilled in the art to which the present invention pertains.

As described above, according to the present invention, when a play list of album items is played, audio representing content of the album is also provided so that a user can recognize the content of the album and easily search for a desired album without seeing the content of the album. In addition, an Audio asset representing the content of the album is combined with a ManifestLink asset without breaking a conventional MPV file structure. Accordingly, a method of playing a multimedia play list according to the present invention can be applied to a CE or IT device complying with the conventional MPV specification.

1. A method of playing a play list for at least one album, the method comprising:
detecting an asset combined with audio representing content of the album; and
playing the audio based on information of the asset.

2. The method of claim 1, wherein the information of the asset comprises identification information of a first asset providing index information of the album and identification information of a second asset providing index information of the audio corresponding to the album.

3. The method of claim 2, wherein the information of the asset further comprises at least one of a volume level of the audio, a playing time of the audio, and a file size of the audio.

4. The method of claim 3, wherein the playing of the audio comprises:
detecting the second asset based on the identification information of the second asset;
detecting information of the second asset;
reading a file of the audio based on the information of the second asset; and
playing the file of the audio based on at least one of the volume level and the playing time of the audio.

5. The method of claim 2, wherein the playing of the audio comprises:
detecting the second asset based on the identification information of the second asset;
detecting information of the second asset; and
reading and playing a file of the audio based on the information of the second asset.

6. A method of playing a multimedia play list for at least one album using a MultiPhotoVideo or MusicPhotoVideo (MPV) file, the method comprising:
detecting a first asset combined with audio representing content of the album in the MPV file;
detecting at least one element at a lower level below the first asset in the MPV file; and
playing index information of the album and the audio based on information of the element.

7. The method of claim 6, wherein the element comprises a first element designating a second asset providing index information of the audio corresponding to the album.

8. The method of claim 7, wherein the playing of the audio comprises:
detecting the second asset in the MPV file based on information of the first element; and
reading and playing a file of the audio based on information of the second asset.

9. The method of claim 8, wherein the element further comprises a second element designating a third asset providing the index information of the album and at least one element related to playback characteristics of the audio, and
the playing of the audio is controlled based on information of the at least one element related to the playback characteristics of the audio.

10. The method of claim 9, wherein the at least one element related to the playback characteristics of the audio comprises at least one of a volume level of the audio and a playing time of the audio.

11. The method of claim 7, wherein the element further comprises a second element designating a third asset providing the index information of the album and at least one element related to playback characteristics of the audio, and
the playing of the audio is controlled based on information of the at least one element related with the playback characteristics of the audio.

12. A method of playing a multimedia play list for at least one album using a MultiPhotoVideo or MusicPhotoVideo (MPV) file, the method comprising:
detecting one of a first asset combined with audio representing content of the album and a second asset designating the first asset in the MPV file;
if the second asset is detected, detecting the first asset in the MPV file based on information of the second asset; and
if the first asset is detected, playing the audio based on information of the first asset.

13. The method of claim 11, wherein the information of the first asset comprises identification information of a third asset providing index information of the album and identification information of a fourth asset providing index information of the audio corresponding to the album.

14. The method of claim 12, wherein the playing of the audio comprises:
detecting the fourth asset in the MPV file based on the identification information of the fourth element; and
reading and playing a file of the audio based on information of the fourth asset.

15. An apparatus for playing a play list for at least one album, the apparatus comprising:
a storage medium which stores media presenting content of the album and a file for playing the play list for the album;
a file software unit which parses information of the file and detects an asset combined with an audio representing the content of the album and information of the asset;
a play controller which plays a file of the audio among the media stored in the storage medium based on the information of the asset detected by the file software unit; and
an output unit which outputs the audio according to control by the play controller.

16. The apparatus of claim 15, wherein the information of the asset comprises identification information of a first asset providing index information of the album and identification information of a second asset providing index information of the audio corresponding to the album,
the file software unit detects the first asset in the file stored in the storage medium based on the identification information of the first asset and detects the second asset in the file stored in the storage medium based on the identification information of the second asset and provides information of the second asset to the play controller, and
the output unit further outputs index information of the album based on the information of the first asset.

17. The apparatus of claim 15, wherein the information of the asset further comprises playback characteristic information of the audio, and
the file software unit provides the playback characteristic information to the play controller.

18. The apparatus of claim 17, wherein the playback characteristic information comprises at least one of a volume level of the audio and a playing time of the audio.

19. A storage medium storing a program for executing a method of playing a play list for at least one album, the method comprising:
detecting an asset combined with audio representing content of the album; and
playing the audio based on information of the asset.

20. A storage medium storing a program for executing a method of playing a multimedia play list for at least one album using a MultiPhotoVideo or MusicPhotoVideo (MPV) file, the method comprising:
detecting a first asset combined with audio representing content of the album in the MPV file;
detecting at least one element at a lower level below the first asset in the MPV file; and
playing index information of the album and the audio based on information of the element.

21. A storage medium storing a program for executing a method of playing a multimedia play list for at least one album using a MusicPhotoVideo (MPV) file, the method comprising:
detecting one of a first asset combined with audio representing content of the album and a second asset designating the first asset in the MPV file;
if the second asset is detected, detecting the first asset in the MPV file based on information of the second asset; and
if the first asset is detected, playing the audio based on information of the first asset.

22. A storage medium storing a MultiPhotoVideo or MusicPhotoVideo (MPV) file for playing a multimedia play list for at least one album, the MPV file comprising:
an asset combined with audio representing content of the album;
at least one element defined at a lower level below the asset;
an asset providing index information of the album detected based on information of the element; and
an asset providing index information of the audio detected based on the information of the element.

23. A storage medium storing a MultiPhotoVideo or MusicPhotoVideo (MPV) file for playing a multimedia play list for at least one album, the MPV file comprising:
an asset combined with audio representing content of the album;
at least one element defined at a lower level below the asset;
an asset providing index information of the album detected based on information of the element;
an asset providing index information of the audio detected based on the information of the element; and
an asset designating the asset combined with the audio.
